(19) United States
(12) Patent Application Publication
(10) Pub. No.: US 2010/0072711 A1
(43) Pub. Date: Mar. 25, 2010

(54) EXPANDABLE METAL-TO-METAL SEAL

(75) Inventors: James C. Doane, Friendswood, TX (US); Larry J. Urban, Santa Fe, TX (US); Clint E. Mickey, Spring, TX (US); Bennett M. Richard, Kingwood, TX (US)

Correspondence Address: CANTOR COLBURN, LLP, 20 Church Street, 22nd Floor, Hartford, CT, 06103, US

(73) Assignee: BAKER HUGHES INCORPORATED, Houston, TX (US)

(21) Appl. No.: 12/233,745

(22) Filed: Sep. 19, 2008

(51) Int. Cl. F16J 15/34; B23P 15/00

(52) U.S. Cl. 277/404; 29/888.3

(57) ABSTRACT

A seal including a seal body having a bridge, a leg extending from the bridge, a gauge ring in operable communication the seal body to cause axial compression thereof, thereby causing the bridge diameter to change, and a seal interface disposed at the seal body. The seal interface including a relatively harder material and a relatively softer material positioned so that the relatively harder material is disposed between the seal body and the relatively softer material. A method for making a seal. A method for sealing an annular geometry. A seal interface.

### BACKGROUND

In the hydrocarbon recovery arts, seals are endlessly used to effect working conditions supportive of desired production fluid recovery. In recent years engineering and development dollars have been spent attempting to improve both pressure holding capacity and longevity. One type of seal receiving significant interest is a metal-to-metal seal due to the fact that of many types metal seals exhibit high temperature tolerance, high-pressure capability, robust chemical resistance, and high durability.

While a good metal to metal seal is extremely durable and desirable, downhole conditions including mud, chemicals, frequent pressure reversals and corrosion of base structures, and geometric inconsistency of base structures against which a seal is intended to be set can make the attainment of a good contact pattern difficult.

### SUMMARY

A seal including a seal body having a bridge, a leg extending from the bridge, a gauge ring in operable communication the seal body to cause axial compression thereof, thereby causing the bridge diameter to change, and a seal interface disposed at the seal body. The seal interface including a relatively harder material and a relatively softer material positioned so that the relatively harder material is disposed between the seal body and the relatively softer material.

A method for making a seal comprising disposing a relatively harder material of a seal interface at an anticipated seal contact area on a seal body. Disposing a relatively softer material of a seal interface at the relatively harder material and radially closer to a surface against which the seal is intended to seal when in use.

A method for sealing an annular geometry including activating a seal body to bridge an extrusion gap between a position of the seal body prior to activation and a surface against which the seal is intended to seal. Urging a relatively harder material with the seal body through a relatively softer material and into contact with the surface against which the seal is to seal.

A seal interface including a relatively harder material, a relatively softer material disposed adjacent the relatively harder material such that the relatively softer material is placeable between the relatively harder material, and a surface against which a seal is desired when in use.

### BRIEF DESCRIPTION OF THE DRAWINGS

Referring now to the drawings wherein like elements are numbered alike in the several Figures:

FIG. 1 is a schematic view of one embodiment of a seal interface disclosed herein;

FIG. 2 is a schematic view of one embodiment of a seal having a seal body and the seal interface illustrated in FIG. 1; and

FIG. 3 is a schematic view of the seal of FIG. 2 in a set position.

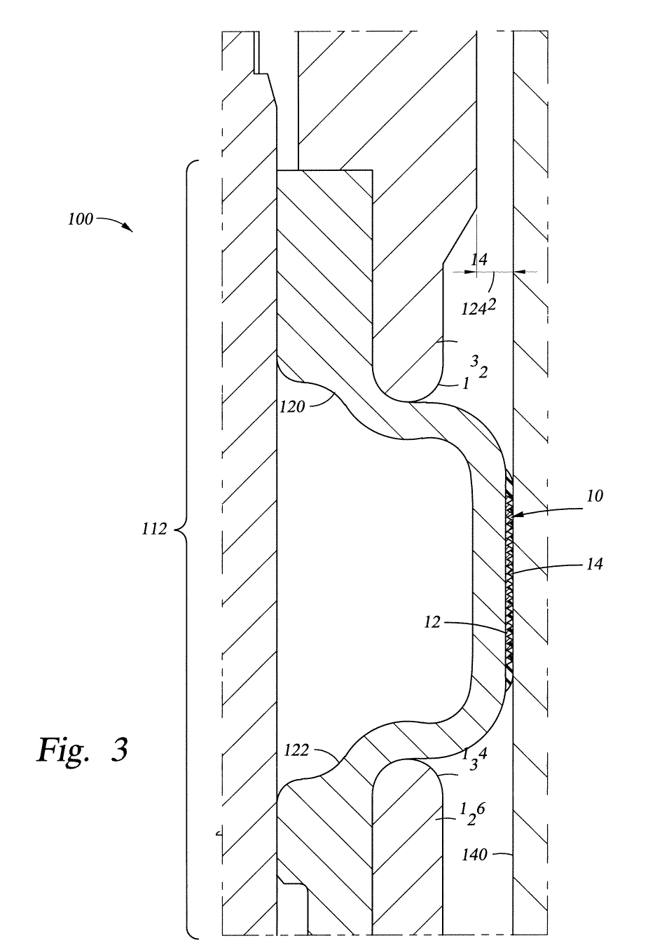

### DETAILED DESCRIPTION

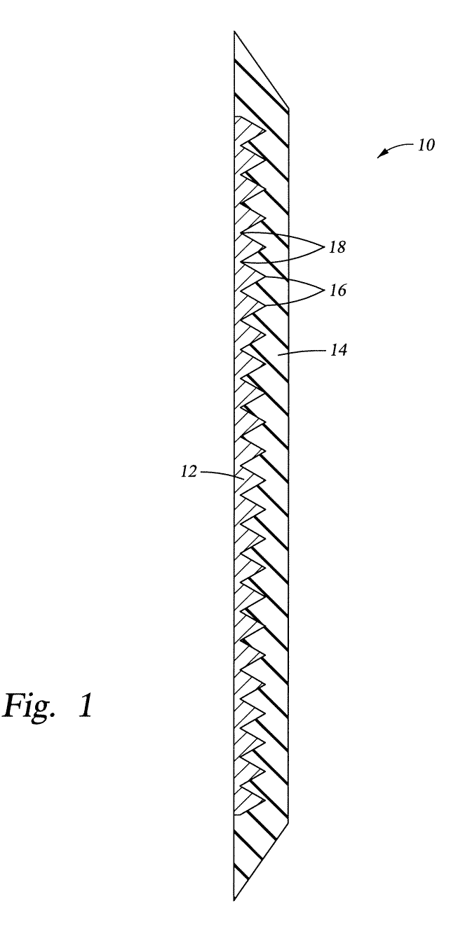

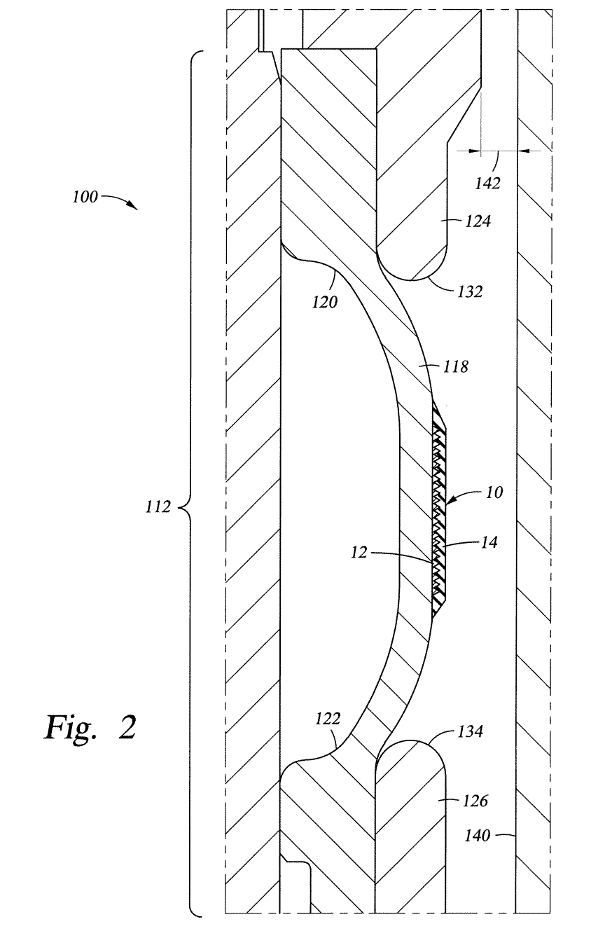

Referring to FIG. 1, an embodiment of a seal interface 10 in accordance with this disclosure is illustrated. The seal interface 10 is intended to be used in conjunction with a seal configuration such as that illustrated in FIG. 2 hereof and identified as numeral 100. It is to be understood that the seal 100 illustrated is but one possible configuration that can benefit from the seal interface 10. Referring back to FIG. 1, the interface 10 comprises a relatively harder material 12 and a relatively softer material 14. In one embodiment, the relatively harder material 12 is one or more of silver, gold, palladium, copper, lead, combinations including at least one of the foregoing, other ductile metals or harder plastics. One property of the material 12 is that the material have sufficient rigidity to span geometric irregularities in a structure such as a tubular in which the seal is intended to be set while maintaining. Material 12 is further configured with a plurality of annular ridges 16. Ridges 16 are interposed with grooves 18. The relatively softer material 14 is as illustrated disposed radially adjacent the material 12. In use the softer material 14 is to be interposed between the material 12 and a surface against which the seal 100 is intended to seal. In one embodiment the softer material 14 is one or more of Polytetrafluoroethylene (PTFE), rubber, Polyetheretherketone (PEEK), Polyetherketone (PEK), etc. with a property of the material 14 being that it be soft enough to deform into surface irregularities in the structure against which the seal is to seal such as pitting from corrosion, for example. When assembled with a complete seal device, the seal interface 10 is positioned such that the material 12 is adjacent a seal body and the material 14 is spaced from the seal body by the thickness of the material 12. In such configuration, the material 14 will be the first material to contact a separate surface against which sealing is to take place. This is followed by contact of one or more of the ridges 16 with that same surface. The body, although not likely itself in contact with the surface will supply the contact force to keep the material 14 and 12 against the surface.

To provide a greater understanding of the function of the seal interface 10 described structurally above, a high level description of one possible seal structure is provided hereunder. Referring to FIG. 2, the seal 100 comprises a seal body 112. Seal body 112 comprises a seal bridge 118 and first and second seal legs 120 and 122. Seal 100 further includes configurations capable of causing the seal body 112 to collapse axially into a set position such as, for example, two gauge rings 124 and 126, each disposed in operable communication with one end of the seal body 112. The gauge rings 124 and 126 are also in supportive communication with the legs 120 and 122, respectively.

Also visible in FIG. 2 are two radiuses 132 and 134 provided one on each of gauge rings 124 and 126, respectively to allow the body 112 to smoothly bend therearound during setting without excessive stress risers.

In operation the exemplary seal 100, due to the shape of body 112, upon axial shortening thereof, will necessarily bulge outwardly. Continued outward bulging into contact with another structure develops a teardrop shape more fully discussed in U.S. application Ser. No. [bao-0188C], which is incorporated herein by reference.

As the seal 100 bulges outwardly (could be configured to bulge inwardly to seal against an inwardly positioned mandrel), interface 10 is moved toward and ultimately into contact with a surface 140 against which the seal 100 is intended to seal. Once contact occurs, the soft material 14 is urged against surface 140 and into any smaller imperfections in that surface 140. This is followed by the material 12 being urged into contact with the surface 140 through the material 14. Ridges 16 operate at this point to cut through the material 14 until they sever a series of annular rings of soft material 14 each one existing within a groove 18. The ridges 16 are at this point in loaded contact with the surface 140. It is to be appreciated that for each two consecutive ridges that are in contact with the surface 140, a ring of soft material 14 is captured by material 12 defining the respective groove and a portion of the surface 140 extending between the consecutive ridges 16. This soft material then is prevented from being squeezed out of the seal area and thus the purpose it serves, to fill small imperfection in the surface 140 remains served for the life of the seal 100. In one embodiment the seal interface 10 is configured such that a minimum of three ridges 16 remain in contact with the surface 140 when the seal is set thereby ensuring a minimum of two annular rings of the softer material 14are trapped in compressive contact with two consecutive grooves 18 and the surface 140. It is to be appreciated that the seal 100 employs sequential material hardness in its construction. Seal body 112 is the hardest of the mobile sealing portions of seal 100; material 12 is next hardest and material 14 is least hardest. This is beneficial in that the seal body 112 is thus able to bridge an extrusion gap 142, material 12 is able to bridge casing eccentricities and material 14 is able to seal corrosion defects.

While preferred embodiments have been shown and described, modifications and substitutions may be made thereto without departing from the spirit and scope of the invention. Accordingly, it is to be understood that the present invention has been described by way of illustrations and not limitation.

1. A seal comprising:
a seal body having:
a bridge;
a leg extending from the bridge;
a gauge ring in operable communication the seal body to cause axial compression thereof, thereby causing the bridge diameter to change; and
a seal interface disposed at the seal body, the seal interface including a relatively harder material and a relatively softer material positioned so that the relatively harder material is disposed between the seal body and the relatively softer material.

2. A seal as claimed in claim 1 wherein the bridge forms a teardrop shape.

3. A seal as claimed in claim 1 wherein the relatively harder material includes a plurality of ridges.

4. A seal as claimed in claim 1 wherein the relatively harder material is a ductile metal.

5. A seal as claimed in claim 1 wherein the relatively harder material is one or more of Silver, gold, palladium, copper, lead, and combinations including at least one of the foregoing.

6. A seal as claimed in claim 1 wherein the relatively softer material is one or more of PTFE, rubber, PEEK, PEK, and combinations including at least one of the foregoing.

7. A seal as claimed in claim 3 wherein at least three ridges are disposed in contact with a surface against which a seal is desired when in use.

8. A seal as claimed in claim 1 wherein at least two rings of the relatively softer material are created between the relatively harder material and a surface against which a seal is being created when in use.

9. A seal as claimed in claim 8 wherein the rings are between two consecutive ridges of the relatively harder material.

10. A method for making a seal comprising:
disposing a relatively harder material of a seal interface at an anticipated seal contact area on a seal body;
disposing a relatively softer material of a seal interface at the relatively harder material and radially closer to a surface against which the seal is intended to seal when in use.

11. A method for making a seal as claimed in claim 10 further including configuring the relatively harder material with a plurality of ridges.

12. A method for sealing an annular geometry comprising:
activating a seal body to bridge an extrusion gap between a position of the seal body prior to activation and a surface against which the seal is intended to seal;
urging a relatively harder material with the seal body through a relatively softer material and into contact with the surface against which the seal is to seal.

13. A method as claimed in claim 12 wherein the urging includes forming annular rings of the relatively softer material with the relatively harder material.

14. A method as claimed in claim 12 wherein the forming is compressive.

15. A method as claimed in claim 12 wherein the forming is by driving a plurality of ridges through the relatively softer material.

16. A method as claimed in claim 15 wherein the number of ridges is three or more.

17. A method as claimed in claim 12 wherein the number of rings is two or more.

18. A seal interface comprising:
a relatively harder material;
a relatively softer material disposed adjacent the relatively harder material such that the relatively softer material is placeable between the relatively harder material and a surface against which a seal is desired when in use.

19. A seal interface as claimed in claim 18 wherein the relatively harder material includes a plurality of ridges.

20. A seal interface as claimed in claim 19 wherein the plurality of ridges are arranged such that the ridges extend into the relatively softer material.

21. A seal as claimed in claim 18 wherein the relatively harder material is one or more of Silver, gold, palladium, copper, lead, and combinations including at least one of the foregoing.

22. A seal as claimed in claim 18 wherein the relatively softer material is one or more of PTFE, rubber, PEEK, PEK, and combinations including at least one of the foregoing.
